(19) United States
(12) Patent Application Publication
(10) Pub. No.: US 2003/0058158 A1
(43) Pub. Date: Mar. 27, 2003

(54) Radar device for measuring water surface velocity

(76) Inventors: Kimble J. Smith, Loveland, CO (US); Scott D. Janson, Loveland, CO (US); Kevin T. Smith, Fort Collins, CO (US)

Correspondence Address: Alan B. Samlan, Knetchel, Demeur & Samlan, Suite 1410, 222 South Riverside Plaza, Chicago, IL, 60606, US

(21) Appl. No.: 09/955,411

(22) Filed: Sep. 18, 2001

(51) Int. Cl. G01S 13/58

(52) U.S. Cl. 342/104; 342/114; 342/115

(57) ABSTRACT

A radar device for measuring the surface velocity of water moving in a horizontal plane in which the radar device is positioned above or below the horizontal plane. The radar device includes a tilt sensor, or accelerometer, to measure the angle of tilt of the radar device with respect to a target point located at a distance from the radar device. The accelerometer generates a signal representing the tilt angle. A processor in the radar device calculates the cosine correction factor that is applied to the measured velocity of the target point. This results in an automatically corrected measured velocity being displayed on the radar device.

### BACKGROUND OF THE INVENTION

This invention relates to measuring devices and more particularly to a surface velocity radar device for measuring water surface velocity.

Radar has been used for years to determine the speed of moving objects. A radar gun transmits and directs a signal or beam of microwave energy (radio waves) having a given frequency at an approaching or receding target. When the beam strikes the target, a small amount of energy from the beam is reflected back to the antenna in the radar device. The reflected signal frequency shifts by an amount proportional to the speed of the target. This is known as the Doppler effect. The radar device then determines the target speed from the difference between the transmitted and reflected signal.

When taking readings of moving water, such as rivers or streams, the radar gun is generally positioned above the stream, on a bridge, or adjacent to the stream, on a riverbank. The radar gun is thus positioned at a vertical angle with respect to the water surface. When the antenna transmits the beam of radio waves, the beam forms an elliptical pattern onto the target area. The size of the elliptical pattern depends on the distance between the antenna and the target.

When the target's path (the water flow direction) is not parallel with the gun's antenna, the radar device displays a speed which is lower than the actual water surface velocity. This is a phenomenon called the cosine effect. When the operator is standing at the side of a moving body of water, there is a horizontal angle introduced when taking a measurement. This is commonly referred to as yaw.

As the angle increases, the target speed erroneously decreases, as Table 1 below shows. At 90° the target speed is 0 which is grossly incorrect. Thus, the speed calculation must compensate for the horizontal angle.

TABLE 1

| Actual | | | | | | | | | | | |
|---|---|---|---|---|---|---|---|---|---|---|---|
| speed | Horizontal angle degrees: | | | | | | | | | | |
| in f/s | 0° | 1° | 3° | 5° | 10° | 15° | 20° | 30° | 45° | 60° | 90° |
| | Displayed speed: | | | | | | | | | | |
| 3 | 3.0 | 3.0 | 3.0 | 3.0 | 3.0 | 2.9 | 2.8 | 2.6 | 2.1 | 1.5 | 0.0 |
| 5 | 5.0 | 5.0 | 5.0 | 5.0 | 4.9 | 4.8 | 4.7 | 4.3 | 3.5 | 2.5 | 0.0 |
| 7 | 7.0 | 7.0 | 7.0 | 7.0 | 6.9 | 6.8 | 6.6 | 6.1 | 4.9 | 3.5 | 0.0 |
| 9 | 9.0 | 9.0 | 9.0 | 9.0 | 8.9 | 8.7 | 8.5 | 7.8 | 6.4 | 4.5 | 0.0 |
| 11 | 11.0 | 11.0 | 11.0 | 11.0 | 10.8 | 10.6 | 10.3 | 9.5 | 7.8 | 5.5 | 0.0 |
| 13 | 13.0 | 13.0 | 13.0 | 13.0 | 12.8 | 12.6 | 12.2 | 11.3 | 9.2 | 6.5 | 0.0 |
| 15 | 15.0 | 15.0 | 15.0 | 14.9 | 14.8 | 14.5 | 14.1 | 13.0 | 10.6 | 7.5 | 0.0 |
| 17 | 17.0 | 17.0 | 17.0 | 16.9 | 16.7 | 16.4 | 16.0 | 14.7 | 12.0 | 8.5 | 0.0 |
| 19 | 19.0 | 19.0 | 19.0 | 18.9 | 18.7 | 18.4 | 17.9 | 16.5 | 13.4 | 9.5 | 0.0 |
| 21 | 21.0 | 21.0 | 21.0 | 20.9 | 20.7 | 20.3 | 19.7 | 18.2 | 14.8 | 10.5 | 0.0 |
| 23 | 23.0 | 23.0 | 23.0 | 22.9 | 22.7 | 22.2 | 21.6 | 19.9 | 16.3 | 11.5 | 0.0 |
| 25 | 25.0 | 25.0 | 25.0 | 24.9 | 24.6 | 24.1 | 23.5 | 21.7 | 17.7 | 12.5 | 0.0 |

The above Table 1 shows the actual velocity speeds in the left column and the displayed speed at antenna to target angles in the right column if the radar gun is not adjusted for the horizontal angle from the position of the gun antenna to the target.

When a vertical (pitch-down) angle is introduced into the measurement, both angles affect the final calculated display speed. Thus it is important to correct for the vertical angle when taking measurements of surface water from an elevated position. (Vertical angles of less than ten degrees (10°) do not result in readings with cosine errors large enough to need corrections.)

In the past, entry of the vertical angle was estimated by the operator and calculated manually or the information was manually entered into the radar device and the software would calculate the cosine correction factor. Applicant's invention provides for automatically entering the vertical or tilt angle into the software for the vertical cosine correction, replacing the operator's manual entry of the past.

In all cases, the radar device is elevated above the water, so the vertical angle must be compensated for. Often the device is used in hazardous conditions, such as flooding, so using the radar device above the water minimizes the risk to the operator. Another advantage of taking measurements above the water is that waterproof instruments are not required.

### OBJECTS AND ADVANTAGES OF THE INVENTION

It is an object of the invention to provide a radar gun that measures surface velocity and automatically compensates for the vertical or tilt angle of the gun with respect to the target.

It is a related object to provide a radar gun with automatic tilt or vertical angle correction so that the gun can be positioned above the water surface, minimizing the hazardous risks to the operator if the operator was required to stand in the moving water.

It is advantageous to be able to take the velocity measurements above the water surface so that waterproof instruments are not required.

### SUMMARY OF THE INVENTION

The inventive device is a radar gun that measures and reports surface velocities. The device contains an accelerometer that has two sensors. The sensors are aligned horizontally with the two sides of the radar gun and separated by 90°. When the operator tilts the radar gun at an upward or downward angle from the horizontal level position, the effect of gravity displaces the sensor. The greater the tilt angle, the greater the effect of gravity on one of the sensors. Simultaneously the other sensor displaces a smaller angle and the effect of gravity on the other sensor is less.

The radar device has a microprocessor that computes the velocity based upon the Doppler shift. Each sensor has a frequency output from which its angle position is determined. The radar gun reads the frequency data from the tilt sensors, and the computer software uses this in calculating the cosine corrected angle of the angle formed by the radar device and the point where the velocity is measured. This internal automatic compensation allows for accurate measurement of the surface velocity of the water.

### DESCRIPTION OF THE DRAWINGS

FIG. 1 is a side elevation view of the inventive radar gun tilted down at a 45° angle.

FIG. 2 is a schematic view of a typical application of the radar gun measuring the surface water velocity of a moving body of water.

FIG. 3 is an electrical schematic diagram of the accelerometer used to determine tilt angle and how it is connected to the radar device's microprocessor.

### DESCRIPTION OF THE PREFERRED EMBODIMENT

Turning first to FIG. 1 there is illustrated a radar gun 10 of the present invention. The gun is manufactured and sold by Decatur Electronics, Inc. of Decatur, Ill. and is sold under the name SVR surface velocity radar device. The gun is similar to other hand held radar devices except that it incorporates an accelerometer 12 having an x-axis sensor 14 and a y-axis sensor 16.

An accelerometer is a sensor that converts acceleration from motion or gravity to an electrical signal. Accelerometers can detect a change in tilt because they can measure and account for the Earth's gravity. An accelerometer that is found to satisfactorily operate is one manufactured by Analog Devices, Inc. One Technology Way, Norwood, Mass. 02062 under model number ADXL202. This is a two-axis accelerometer that is suitable for measuring static acceleration (e.g. gravity).

The outputs are duty cycle modulated (DCM) signals whose duty cycles (ratio of pulse-width to period) are proportional to the acceleration in each of the two axes (i.e. x-axis and y-axis). Duty cycle modulated signals are the same as pulse width modulation (PWM). The x and y-axis sensors generate a PWM signal internally to the accelerometer 12 that is related to the amount of acceleration the sensor 12 senses.

The sensor is designed to provide a 50% duty cycle signal when it is sensing 0 g (where g is the unit of measurement of the earth's gravitational pull). The accelerometer 12 is also designed with a settable output frequency so that it can interface with a variety of microprocessor counters requiring no A/D converter. The output frequency is set by adjusting a resistor to the circuits as will be described below.

A PWM circuit makes a square wave with a variable on-to-off ratio. The average time on can vary from 0 to 100 percent. In this manner, the sensor can relay data to a microprocessor 18. When the on-duty time of the square wave coming from the sensor is longer, the g force being sensed by the sensor is higher.

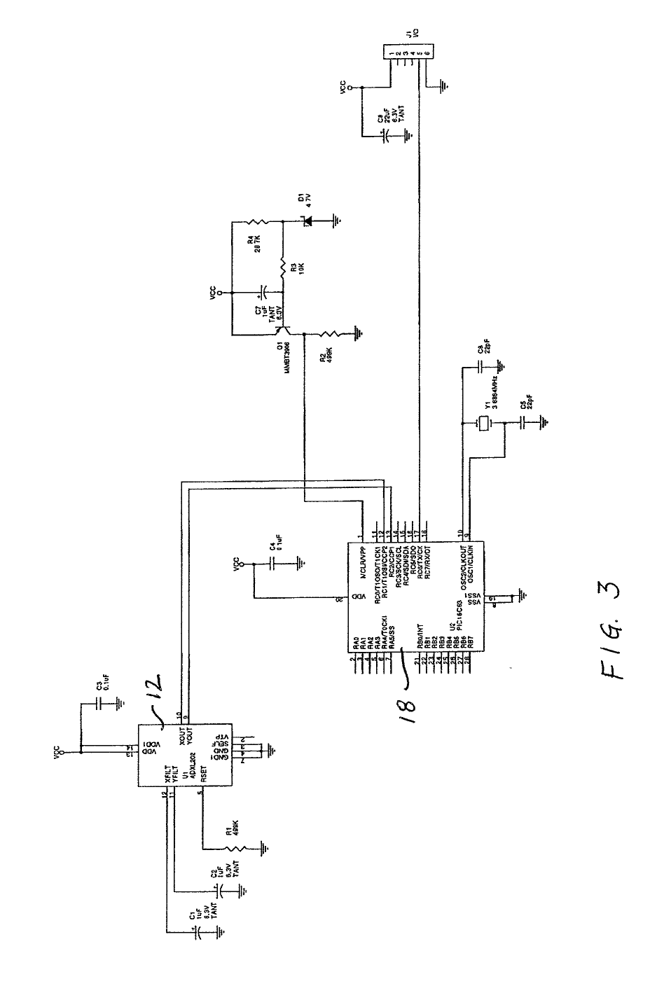

As seen in FIG. 3, the accelerometer 12 generates an output frequency by placing a resistor 18 between pin 5 of the accelerometer 12 and ground. A 499 k ohm resistor divided into 125 k ohm resistors is used to obtain the frequency. This results in a 0 g frequency of 250 Hz. At 0 g, the accelerometer 12 produces a 50 percent duty cycle waveform. This is modified by accelerations at a rate of approximately 12.5 percent per g.

The accelerometer 12 is calibrated to distinguish between up and down as it is tilted. To calibrate the accelerometer 12 it is first mounted upright and rotated through 360°, starting with the accelerometer 12 being level with respect to the horizontal. This determines how to set the highest, upright, and lowest, upside-down values. For example, if the unit is oriented straight down towards the earth (+1 g) the x-axis sensor 14 will produce a duty cycle of approximately 55 percent. If the same sensor is oriented away from the earth (−1 g) the sensor 14 will produce a duty cycle of approximately 45 percent. The minimum and maximum values from the x-axis sensor 14 and y-axis sensor 16 are stored in memory in the microprocessor 18 to be used in the actual angle calculation.

For example, it the radar gun 10 and internally mounted accelerometer 12 are pointed down at an angle from the horizontal and the y-axis sensor 16 (the vertically oriented sensor) produces a duty cycle of 53 percent, then the angle that is producing that reading is calculated as follows:

Pitch angle=asin (acceleration in the x direction/1 g calibration from the x sensor reading). Thus pitch angle=asin (53/55).

Pitch angle=asin (0.9636)=74.5° or 90°−74.5°=15.5° down.

At the same time that the microprocessor is receiving a reading from the y-axis sensor 16 which is used in determining if the radar gun 10 is pointing upward or downward. The radar gun 10 can be pointed downward if the unit is mounted on a pole and lowered over a bridge or other structure to measure the surface water velocity. By combining the output of both the x-axis sensor 14 and the y-axis sensor 16, the full 360° of rotation of the gun 10 can be measured.

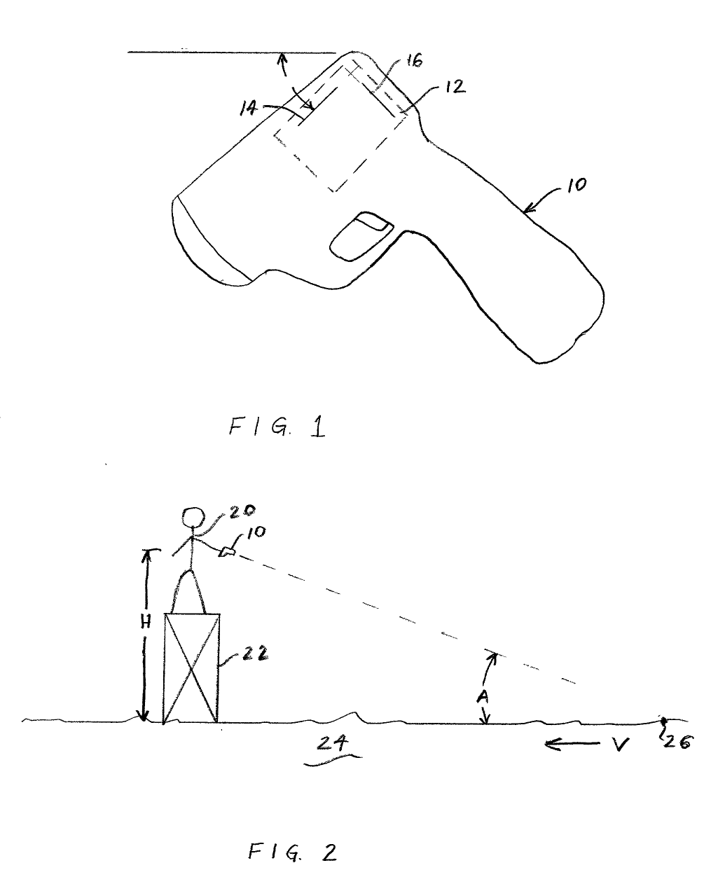

Turning to FIG. 2, there is illustrated a person 20 standing on a bridge or platform 22 a height H above a stream or other moving body of water 24. The water is shown moving at a velocity V in the left to right direction. If the person 20 attempts to take a reading of the water velocity by aiming the radar gun 10 at a point 26, the reading will not be accurate unless the measurement takes into account the cosine effect. This is because the point 26 on the water is moving at an angle A to the radar gun 10. Thus the rate of speed or relative speed between point 26 and the gun 10 is lower and the displayed speed on the radar gun 10 will also be lower.

The true speed can be calculated from the indicated speed, using the following formula:

True Speed=Indicated Speed/Cosine A

If we assume the angle A is 10°, the cosine of A is 0.9848.

If the indicated speed on the radar gun is 10 feet per second and no cosine correction is made, then the actual speed of the water is 11.17 feet per second.

By placing the accelerometer in the radar gun 10, the tilt angle of the gun can be automatically measured as described above. The accelerometer 12 sends a signal to the microprocessor 18 corresponding to the tilt angle of the accelerometer. The cosine correction is automatically calculated by the microprocessor and multiplied against the measured speed of the water. This calculates the actual velocity of the water, which is displayed on the radar gun. The water velocity can also be displayed on a graph or the information can be stored on any suitable media for later retrieval.

Thus there has been provided a surface velocity radar gun with automatic cosine correction for measuring water velocity at an angle that fully satisfies the objects set forth above. While the invention has been described in conjunction with a specific embodiment, it is evident that many alternatives, modifications and variations will be apparent to those skilled in the art in light of the foregoing description. Accordingly, it is intended to embrace all such alternatives, modifications and variations as fall within the spirit and scope of the appended claims.

What is claimed is:

1. A radar device for measuring velocity comprising:
a radar gun with means for generating a signal at a predetermined frequency directed at an object, the radar gun oriented at a vertical angle with respect to the object,
means for receiving the signal after it is reflected from the object, the reflected signal having a shift in the frequency that is proportional to the velocity of the object,
means for calculating the velocity of the object based upon the frequency shift, and
means for correcting the calculated velocity to a corrected calculated velocity of the object if the radar device is positioned at the vertical angle with respect to the object.

2. The radar device of claim 1 wherein the radar device is positioned above the object and generates the signal at an angle with respect to a horizontal plane in which the object is moving, the angle introducing an error factor in the measured speed of the object.

3. The radar device of claim 2 wherein the means for correcting the calculated velocity comprises an accelerometer that detects the angle at which the radar gun is oriented, the accelerometer sensing the angle and generating a signal corresponding to the angle.

4. The radar device of claim 3 wherein the signal generated by the accelerometer is received by a processor in the radar device, the processor processing the signal to generate a correction factor that corrects the calculated velocity to the corrected calculated velocity to compensate for the angle.

5. The radar device of claim 4 wherein the correction factor is a cosine correction factor, the factor dependent on the angle.

6. In a radar gun having means for measuring a velocity of an object moving in a substantially horizontal direction, the improvement comprising:
means for correcting the velocity measured to correct for the radar gun being disposed above or below the horizontal thus resulting in an erroneous reading due to the radar gun being disposed at an angle with respect to the horizontal, the means for correcting the velocity measured being a sensor that senses the angle of the radar gun with respect to the horizontal.

7. The radar gun of claim 6 wherein the sensor provides an output signal corresponding to the angle sensed.

8. The radar gun of claim 7 and further comprising a processor in the radar gun that receives the output signal, the processor computing a correction factor dependent on the output signal, the correction factor applied to the velocity measured to produce a corrected measured velocity that more closely corresponds to the velocity of the object.

9. The radar gun of claim 8 wherein the sensor comprises an x-axis sensor and a y-axis sensor to determine both the angle and the orientation of the radar gun.

10. A radar gun having tilt angle compensation comprising:
a tilt sensor mounted in the radar gun to provide an output signal that includes a tilt angle component,
a processor mounted in the radar gun to receive the output signal,
the processor calculating the tilt angle of the radar gun with respect to a horizontal plane.

11. The radar gun of claim 10 wherein the radar gun has a radar antenna operative to provide an output signal in response to energy reflected from, and indicative of, a distant target.

12. The radar gun of claim 11 wherein the output signal is indicative of the measured velocity of the distant target.

13. The radar gun of claim 12 wherein the processor further provides a correction factor correlating to the tilt angle that is applied to the measured velocity to provide a corrected calculated velocity of the distant target.
